(19) United States
(12) Patent Application Publication
(10) Pub. No.: US 2016/0001405 A1
(43) Pub. Date: Jan. 7, 2016

(54) AN ANTI-FROZEN PROCESSING APPARATUS AND METHOD

(71) Applicants: Tao FENG, Shanghai (CN); LINDE AKTIENGESELLSCHAFT, München (DE)

(72) Inventor: Tao Feng, Shanghai (CN)

(21) Appl. No.: 14/770,208

(22) PCT Filed: Feb. 28, 2013
(86) PCT No.: PCT/CN2013/071985

§ 371 Date: Aug. 25, 2015

(51) Int. Cl. B23P 11/02

(52) U.S. Cl. CPC B23P 11/025

(57) ABSTRACT

The invention provides an anti-frozen processing apparatus and method used in a shrink fitting process of an inter component and outer component, which can reduce and eliminate the icy layer on the surface of low temperature inner component, and also can increase the productivity, improve the fitting quality and reduce the nitrogen consumption.

The invention is relates to an anti-frozen processing apparatus and method, in particular an anti-frozen processing apparatus and method used in a shrink fitting process of an inner component and an outer component.

### BACKGROUND ART

Shrink-fitting is a technique in which pieces of a structure are heated or cooled, employing the phenomenon of thermal expansion, to make a joint. For many traditional applications, fitting is carried out by heating the outer components or force fitting. Recently, a new method of liquid nitrogen shrink fitting offers a better alternative for fitting. With liquid nitrogen shrink fitting the necessary clearance is obtained by shrinking the inner component (instead of expanding the outer one). This is achieved by immersing the inner component in a bath of liquid nitrogen at a temperature of −196° C. After assembly the inner component warms up, expanding to form a tight distortion free interference fit.

In the typical liquid nitrogen shrink fitting process, taking the assembly of the shaft and its bushes as an example, the robot arm firstly picks the inner component (shaft) from the conveyor, sends it immersed in the liquid nitrogen of the batch for pre-defined time, takes the shaft out of the batch and leaves it at the position on the assembly table, then a plunger pushes the shaft into the bushes which can be multiple parallel, at last the assembly finished part is conveyed to the heating position to remove the freezing ice on the shaft surface, and goes for downstream steps.

One big problem in the process is the freezing ice formed on the inner component surface which is at a very low temperature after taken out of the liquid nitrogen bath. When the remaining liquid nitrogen on its surface vaporizers, the shaft will have a layer of ice covered with the effect of the moisture air in the ambient environment. The icy layer will turn thicker with time goes on, so it can generate a problem that the “thicker” shaft can not be inserted in the bushes, especially the last several ones in parallel. Additionally, the icy layer remained at the fitting position can also bring some quality issues, like corrosion, in long term.

In some occasions, the parts would be heated to remove the icy layer after the fitting , which could help a little but is not able to resolve the root cause.

Taking a close look at the steps in which the icy layer can grow on the shaft surface in the process:

1. The step that robot arm picks shaft out of liquid nitrogen and puts it on the assembly table.

At the beginning, the shaft's surface is covered by the remaining liquid nitrogen layer, so the metal surface does not touch the wet air immediately. Second reason, there is less moisture in the air near the opening of liquid nitrogen bath.

On the way of transferring to the assembly table, with the vaporization of the liquid nitrogen layer on the surface and more moisture in the ambient, icy layer becomes forming and growing on the metal surface.

2. At the assembly table, shaft is slowly pushed into bushes.

Its a critical spot. There is more moisture in the area, and icy layer will keep growing thicker here. It becomes a problem when the diameter of shaft and icy layer exceeds the inner diameter of the bushes.

So some measures should be taken to prevent the icy layer generation at least before the shrink fitting takes place, that is during the movement of the shaft from the liquid nitrogen bath to the assembly table and the period of pushing the shaft toward the bushes on the assembly.

### SUMMARY OF THE INVENTION

The invention discloses an anti-frozen processing apparatus used in a shrink fitting process of an inter component and an outer component, which can reduce and eliminate the icy layer on the surface of low temperature inner component, and also can increase the productivity, improve the fitting quality and reduce the nitrogen consumption.

The processing apparatus comprises an operating device for picking the inner component from the conveyor, sending the inner component in a container which is full of liquid nitrogen for pre-defined time, then taking the inner component out of the container and leaving the inner component at the position on an assembly table, and a conveying device for conveying the inner component into engagement with an outer component which is aligned with the inner component.

The processing apparatus further comprises a nozzle device for blowing nitrogen to the inner component during the movement from the container to the assembly table and for continually providing the nitrogen to the inner component at least before the fitting of the inner component and the outer component takes place, so as to prevent the icy layer generation.

In particular, a first nozzle of the nozzle device is arranged on the operating device, while a second nozzle of the nozzle device is arranged on the conveying device.

Furthermore, the first nozzle can be arranged just above the shaft.

For helping provide a better nitrogen gas enclosure around the inner component, the first nozzle is designed to have a shape corresponding to the shape of the surface of the inner component, and is provided at least one small holes towards the inner component.

The second nozzle is for example a ring nozzle, so as to blow the nitrogen to the inner component in a surrounding form. Both nitrogen injections of the first and second nozzles are controlled by solenoids and the signal that show the inner component is at the position.

The invention further discloses an anti-frozen processing method used in a shrink fitting process of an inter component and an outer component, which comprises the steps of:

picking the inner component from the conveyor, sending the inner component in a container which is full of liquid nitrogen for pre-defined time;

taking the inner component out of the container and leaving the inner component at the position on an assembly table;

conveying the inner component into engagement with an outer component which are aligned with the inner component;

For preventing the icy layer generation on the surface of the inner component, the method further comprises the steps of:

blowing nitrogen to the inner component during the movement from the container to the assembly table;

triggering the nitrogen flow when the inner component is placed in position on the assembly table;

then continually providing the nitrogen to the inner component at least before the fitting of the inner component and the outer component takes place.

This anti-frozen processing method of the invention can reduce and eliminate the icy layer on the surface of low temperature inner component, and since only some components of the processing apparatus are provided with the nitrogen nozzles, the assembly can be simplified and the nitrogen consumption can be reduced, thus reducing the cost.

### BRIEF DESCRIPTION OF THE DRAWINGS

Now the anti-frozen processing apparatus and method used in the shrink fitting process of this invention will be illustrated with reference to the accompanying drawings, in which:

FIG. 1 is a schematic view of the operating device of the processing device according to this invention;

FIG. 2 is a schematic view of the conveying device of the processing device according to this invention;

FIG. 3 a schematic view of the first nozzle of the processing device according to this invention;

FIG. 4 is a top view of the small hoes arranged at the first nozzle; and

FIG. 5 is a schematic view of the second nozzle of the processing device according to this invention.

### DETAILED DESCRIPTION OF THE INVENTION

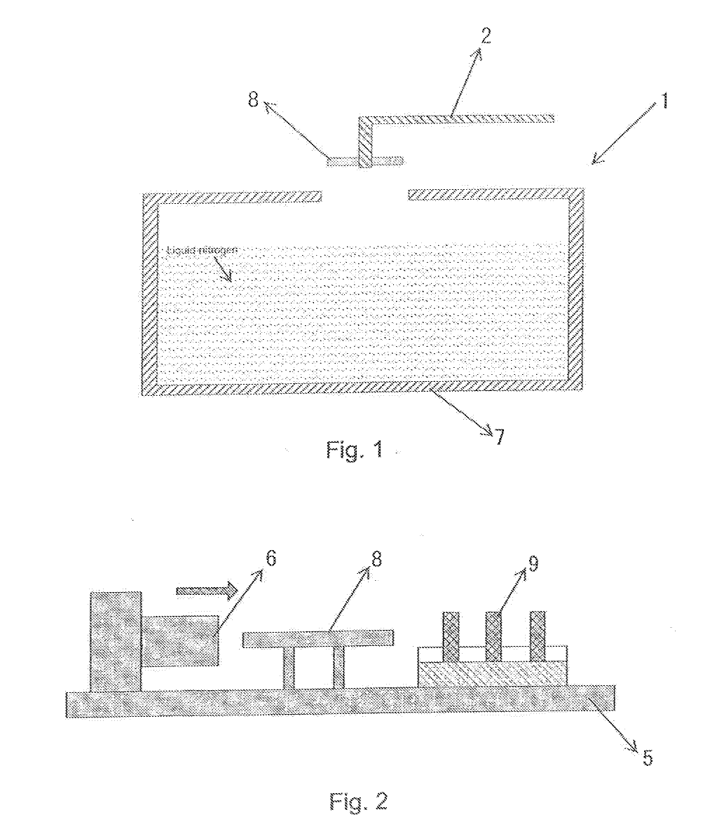

Now with respect to FIG. 1 which illustrates an anti-frozen processing apparatus used in a shrink fitting process of an inter component and an outer component. Taking the shrink fitting of a shaft and its bushes as an example, the anti-frozen processing apparatus is used to prevent the icy layer forming on the shaft surface during the shrink fitting process of the shaft and its bushes. In this figure, this processing apparatus is generally referenced 1 and comprises a robot arm 2 and a plunger 6.

The robot arm 2 can be used to pick the shaft 8 (inner component) from the conveyor (not shown), send it immersed in the liquid nitrogen of an insulation vessel 7 which is full of liquid nitrogen of −196° C. for pre-defined time, then take the shaft out of the vessel 7 and leave it at the position on the assembly table 5. Although in FIG. 2 the shaft 8 is operated by the robot arm 2, any other appropriate operating device could be used to operate the shaft 8.

The plunger 6 can be used to push the shaft 8 into at least one bushes 9 which are aligned with the shaft. After the shaft 8 has been engaged with the bushes 9, the shaft 8 warms up, expanding to form a tight distortion free interference fit with the bushes 9. Although in FIG. 1 the shaft 8 is conveyed into engagement with the bushes 9 by means of the plunger 6, any other appropriate conveying device could be used to convey the shaft 8.

To prevent the icy layer forming on the surface of the shaft 8, the processing device 1 of the invention further comprises a first nozzle 3 and a second nozzle 4 for blowing nitrogen gas to the shaft 8. The first nozzle 3 is arranged at the robot arm 2, which is used to grasp and handle the shaft 8. The first nozzle 3 is arranged just above the shaft 8 and blows nitrogen gas to the shaft 8 during the movement from the vessel 7 to the assembly table, so as to push away the ambient moisture during the transportation.

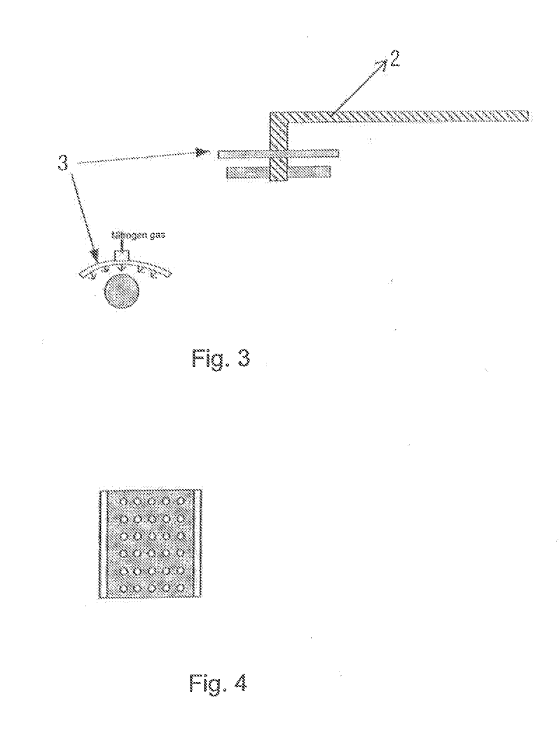

As shown in FIG. 3, the first nozzle 3 is designed to have a shape corresponding to the shape of the surface of the shaft 8, such as arc surface. At the first nozzle 3 there are arranged multiple small holes towards the shaft 8, which can be uniformly distributed on the first nozzle 3, so as to help providing a better nitrogen gas enclosure around the shaft and keep the shaft free of moisture until it is placed at the assembly table.

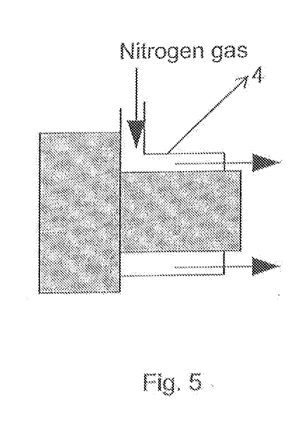

Now with respect to FIG. 5, the second nozzle 4 is arranged at the plunger 6 on the assembly table 5 and has a ring-like shape. Once the shaft 8 is placed in position on the assembly table, the nitrogen flow of the second nozzle 4 is triggered, which can continue providing the nitrogen blow to the shaft until it is inserted in the bushes 9. The nitrogen blow from the second nozzle 4 can push away the ambient air with moisture and prevent freezing ice forming on the shaft surface when the shaft 8 is on the assembly table and being pushed into the bushes.

Both nitrogen injections of the first and second nozzles are controlled by solenoids and the signal that show the shaft is at the position.

However, since the detailed nozzle design is well known, a detail description thereof will be omitted.

Hereinafter, an anti-frozen processing method according to this invention will be described in detail, which is used to prevent the icy layer forming on the shaft surface during the shrink fitting process of the shaft and its bushes.

This method comprises the following steps of: picking the shaft 8 from the conveyor, sending the shaft 8 in the vessel 7 which is full of liquid nitrogen of −196° C. for pre-defined time; taking the shaft 8 out of the vessel 7 and leaving the shaft at the position on the assembly table 5; conveying the shaft 8 into engagement with the bushes 9 which are aligned with the shaft 8;

To prevent the icy layer generation, this anti-frozen processing method can comprise blowing nitrogen to the shaft 8 during the movement from the vessel 7 to the assembly table 5 and triggering the nitrogen flow of the second nozzle 4 when the shaft is placed in position on the assembly table 5, then continually providing the nitrogen to the shaft 8 until at least before the fitting of the shaft 8 and the bushes 9 takes place.

In particular, the first nozzle 3 is arranged at the robot arm 2, while the second nozzle 4 is arranged at the plunger.

Preferably, in this anti-frozen processing method, the first nozzle 3 is arranged just above the shaft 8 and blows the nitrogen to it downwardly, for preventing icy layer forming on the surface of the shaft.

Furthermore, the first nozzle 3 is designed to have a shape corresponding to the shape of the surface of the shaft 8, such as arc surface, and at the first nozzle 3 there are arranged multiple small holes towards the shaft 8, which can be uniformly distributed on the first nozzle 3, so as to help providing a better nitrogen gas enclosure around the shaft.

The second nozzle 4 is for example a ring nozzle, so as to blow the nitrogen to the shaft 8 in a surrounding form.

Although in the description, the anti-frozen processing apparatus and the anti-frozen processing method of this invention are described with respect to the shrink fitting of the shaft and its bushes, then can also be used in the shrink fitting process of any other inner component and outer component.

1-12. (canceled)

13. An apparatus (1) used to shrink fit an inner component (8) with an outer component (9), comprising:
an operating device (2) for picking the inner component from a conveyor, moving the inner component to a container (7) of liquid nitrogen for a pre-defined time, and moving the inner component from the container to a position on an assembly table (5);
a conveying device (6) for conveying the inner component into engagement with the outer component aligned with the inner component; and
a nozzle device (3,4) for blowing nitrogen to the inner component during movement from the container to the assembly table and for continually providing nitrogen to the inner component at least before the engagement of the inner component with the outer component occurs.

14. The apparatus of claim 13, wherein the nozzle device comprises a first nozzle (3) arranged at the operating device, and a second nozzle (4) arranged at the conveying device.

15. The apparatus of claim 14, wherein the first nozzle comprises at least one hole directed toward the inner component.

16. The apparatus of claim 14, wherein the first nozzle is arranged above the inner component.

17. The apparatus of claim 14, wherein the first nozzle comprises a shape corresponding to a surface shape of the inner component.

18. The apparatus of claim 13, wherein the operating device comprises a robot arm.

19. The apparatus of claim 13, wherein the conveying device comprises a plunger.

20. The apparatus of claim 14, wherein the second nozzle comprises a ring nozzle.

21. The apparatus of claim 14, further comprising solenoids for controlling nitrogen flows from the first and second nozzles, and for controlling a signal representing the inner component is at a position for engaging the outer component.

22. A method used for shrink fitting inner component (8) with an outer component (9), comprising:
picking the inner component from a conveyor;
moving the inner component to a container (7) of liquid nitrogen for a pre-defined time;
removing the inner component from the container to a position on an assembly table (5);
blowing nitrogen to the inner component during the removing of the inner component from the container to the assembly table;
conveying the inner component for engaging the outer component aligned with the inner component;
triggering a nitrogen flow when the inner component is placed in the position on the assembly table; and
continually providing the nitrogen flow to the inner component at least before the engaging of the inner component with the outer component.

23. The method of claim 22, wherein the blowing comprises directing the nitrogen downward to the inner component.

24. The method of claim 22, wherein the blowing comprises directing the nitrogen to surround the inner component.
